(19) United States
(12) Patent Application Publication
(10) Pub. No.: US 2007/0174726 A1
(43) Pub. Date: Jul. 26, 2007

(54) System and method for monitoring group of devices on network

(75) Inventors: Gung-eun Nam, Suwon-si (KR); Kwang-yun Na, Yongin-si (KR); Kee-wook Na, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/526,596

(22) Filed: Sep. 26, 2006

(30) Foreign Application Priority Data
Nov. 2, 2005 (KR) 10-2005-0104150

(51) Int. Cl. G06F 11/00

(52) U.S. Cl. 714/43

(57) ABSTRACT

A system and a method are provided for monitoring fault of a group including a plurality of device connected via a network, and taking action about the fault. The system includes: one or more slave devices testing fault of a belonging device and outputting the test result, and a master device receiving the test result from the one or more slave devices.

### CROSS-REFERENCE TO RELATED PATENT APPLICATIONS

This application claims priority from Korean Patent Application No. 10-2005-0104150, filed on Nov. 2, 2005, in the Korean Intellectual Property Office, the disclosure of which is incorporated herein in its entirety by reference.

### BACKGROUND OF THE INVENTION

1. Technical Field

Systems and methods consistent with the present invention relate to monitoring of a device, and more particularly, to monitoring fault of a group consisting of a plurality of devices connected via a network, and taking action about the fault.

2. Description of the Related Art

As the function of related art home electronic devices has been recently advanced and become complicated, one device is comprised of different components. Therefore, for maintenance of an apparatus, when fault occurs, it is necessary to immediately detect the fault and to grasp a component of which fault occurs. However, it is difficult to effectively perform monitoring on fault using a related art apparatus for individually operating.

### SUMMARY OF THE INVENTION

The present invention provides a system and a method for performing automatic monitoring on a plurality of device groups.

The present invention also provides a system and a method in which a plurality of device groups is connected to the network to constitute a small-scale network, a module for self-testing is added to each device to detect fault of a device and a master device collects a fault test result to report the fault test result to a user according to a procedure.

According to an aspect of the present invention, there is provided a system for monitoring a group of devices on a network, the system comprising: one or more slave devices testing fault of a belonging device and outputting the test result; and a master device receiving the test result from the one or more slave devices.

According to another aspect of the present invention, there is provided a system for monitoring a group of devices on a network, the system comprising: a fault testing unit testing fault of a belonging device and outputting the test result; and a monitoring administration unit instructing fault testing to the fault testing unit and transmitting the test result input from the fault testing unit to a master device within the group when operating in a slave mode.

When operating in a master mode, the monitoring administration unit may receive the fault test result from the other devices within the group, analyze the received test result, and if it is determined that a device of which fault occurs exists, output a fault breakdown, and the system may further comprise a monitoring result processing unit outputting the fault breakdown input from the monitoring administration unit.

When operating in a master mode, the monitoring administration unit may request the fault test in the other devices within the group and when operating in a slave mode, the monitoring administration unit may instruct the fault test to the fault testing unit if it receives a fault test request.

The system may further comprise an information storage unit including service configuration information in which action matters when fault occurs are recorded, wherein the monitoring result processing unit outputs the fault breakdown by referring to the service configuration information.

The information storage unit may further comprise group management information in which information about devices within the group is recorded, and the system may further comprise a group management module managing group joining of a new device using the group management information and determining one device among devices within the group as a master device operating in a master mode and the other device as a slave device operating in a slave mode.

The group management module may determine a device among devices within the group of which master rank is the highest as the master device by referring to the group management information.

When operating in the master mode, if the group management module receives a group subscription request, it may add information about the device demanding subscription to the group management information, and if it receives a request of the information about the master device, it may send information including an identifier and a master rank of a belonging device in response to the information request.

The group management module may request information about the master device in the other devices within the group, if a master rank of the belonging rank is higher than a master rank of the master device included in the received information or fails receiving of the information about the master device, notify the other devices within the group that the belonging device is set to the master device, and if not, the group management module may request group joining in the master device.

The information storage unit may further comprise an individual component list in which information about each component constituting the belonging device is recorded, and if the fault testing unit receives the test instruction, it may perform a self-test on components belonging to the individual component list and output the self-test result as the test result.

The information storage unit may further comprise a common component list in which information about each component of the devices within the group is recorded, and when operating in the master mode, the monitoring management unit may prepare the fault breakdown by referring to the common component list if it receives the test result from the other devices within the group.

When operating in the master mode, the monitoring management unit may request the fault test to the other devices within the group in each period.

The service configuration information may be different according to a type of the belonging device.

According to another aspect of the present invention, there is provided a method of monitoring a group of devices on a network, the method comprising: receiving a fault test request from a master device within the group; if the request is received, testing fault of a belonging device; and transmitting the test result to the master device.

According to another aspect of the present invention, there is provided a method of monitoring a group of devices on a network, the method comprising: requesting a fault test to each device within the group; receiving the test result from each device in response to the request; if the received test result is analyzed and it is determined that a device of which fault occurs exists, preparing a fault breakdown; and outputting the fault breakdown.

According to another aspect of the present invention, there is provided a method of monitoring a group of devices on a network, the method comprising: determining a device having the highest mask rank among devices within the group as a master device of the group and determining the other device as a slave device; requesting a fault test in the slave device using the master device; if the fault test request is received, testing fault of a device; transmitting the test result to the master device; if the test result received from the slave device and it is determined that a device of which fault occurs exists, preparing a fault breakdown; and outputting the fault breakdown.

### BRIEF DESCRIPTION OF THE DRAWINGS

The above and other aspects of the present invention will become more apparent by describing in detail exemplary embodiments thereof with reference to the attached drawings in which:

FIG. 1 illustrates a structure of a device group on a network according to an exemplary embodiment of the present invention;

FIG. 2 illustrates an example of a device network configuration according to an exemplary embodiment of the present invention;

FIG. 3 illustrates an internal structure of a monitoring system according to an exemplary embodiment of the present invention;

FIG. 4 illustrates an example of a common component list according to an exemplary embodiment of the present invention

FIG. 5 illustrates an example of an individual component list according to an exemplary embodiment of the present invention;

FIG. 6 illustrates an example of a master ranking rule according to an exemplary embodiment of the present invention;

FIG. 7 illustrates an example of service configuration information according to an exemplary embodiment of the present invention;

FIG. 8 illustrates an example of a component-wise self-test result according to an exemplary embodiment of the present invention;

FIG. 9 illustrates a monitoring operation mechanism of a slave device according to an exemplary embodiment of the present invention

FIG. 10 illustrates a monitoring operation mechanism of a master device according to an exemplary embodiment of the present invention; and

FIG. 11 illustrates a master device decision mechanism according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

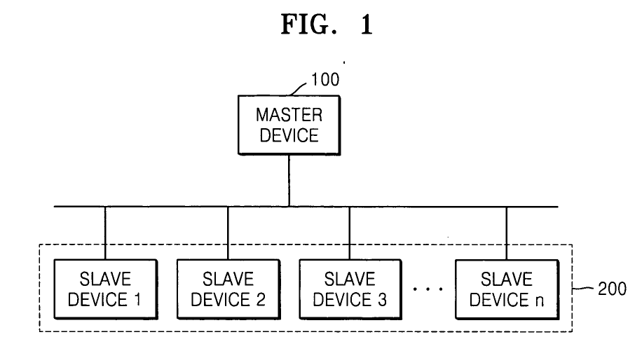

FIG. 1 illustrates a structure of a device group on a network according to an exemplary embodiment of the present invention. In a monitoring system of FIG. 1, a plurality of device groups is connected to one another via a network; one of devices on the network operates as a master device 100 and the other devices operate as slave devices 1 . . . n 200.

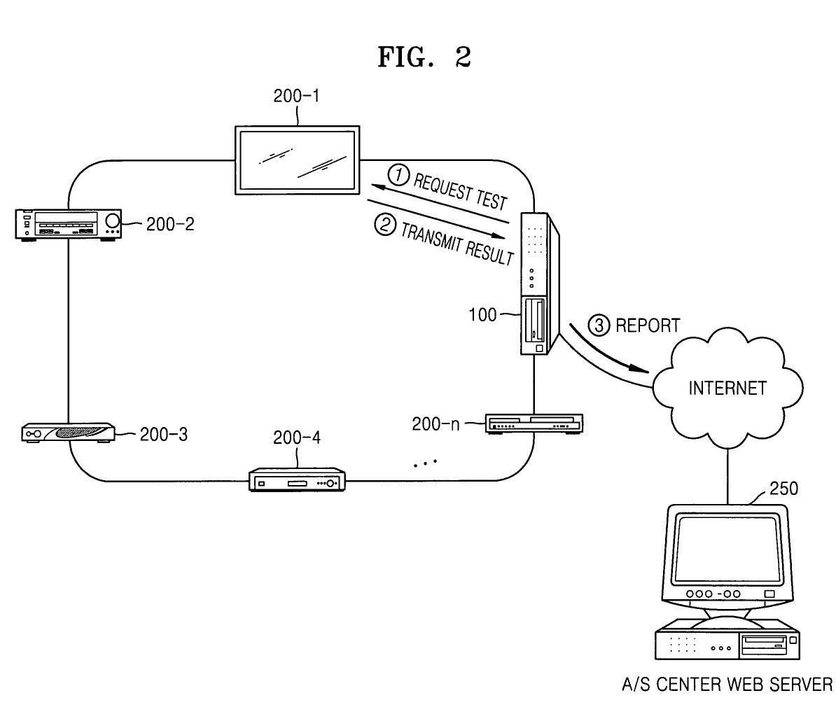

FIG. 2 illustrates an example of a device network configuration according to an exemplary embodiment of the present invention. Referring to FIG. 2, a personal computer (PC) 100 is configured as a master device and home electronic devices 200-1 through 200-n, such as (but not limited to) television (TV) and digital video disk (DVD) player are configured as slave devices, so as to constitute a small-scale network. The master device 100 requests fault testing on one or more slave devices 200-1 through 200-n, and receives a self-test result in response thereto. Moreover, the received self-test result is collected and analyzed, so that a fault breakdown to be reported to a user is prepared. The fault breakdown information is output using a designated method.

In the example of FIG. 2, since a PC having the Internet connection function is the master device, the PC can register the fault breakdown after connecting to a web server 250 of an A/S center through the Internet. Each device within a network includes a communications module (is not illustrated) for communicating with another device. Thus, each device can be coupled in the form of a chain using a simple interface such as a serial cable. Alternatively, a network can be constituted by using a wireless interface such as an infrared data association (IRDA).

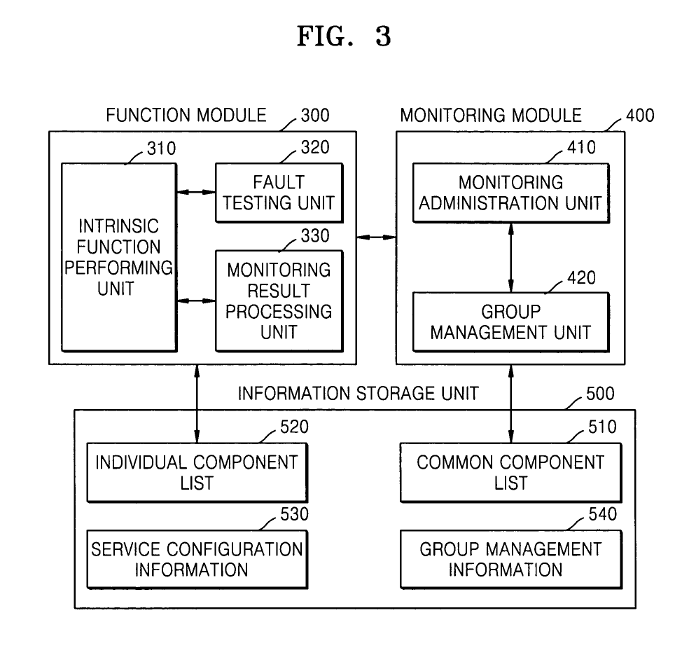

FIG. 3 illustrates an internal structure of a monitoring system according to an exemplary embodiment of the present invention. The internal structure of each device connected to the monitoring network illustrated in FIG. 1 is illustrated in FIG. 3. The master device 100 and the slave device 200 are not fixed, but are dynamically changed according to the network configuration. That is, since the device within the group is the master device operating in a master mode or the slave device operating in a slave mode according to situations, the device may have the substantially same configuration.

Referring to FIG. 3, the monitoring system includes a function module 300, a monitoring module 400, and an information storage unit 500 for storing information required for monitoring. The function module 300 and the monitoring module 400 are independent of each other, and the monitoring system does not include an interface (I/F) module (not shown) for communications between modules. The interface module can be implemented as a simple interface channel, such as a serial communications module, but not limited thereto.

A fault testing unit 320 and a monitoring result processing unit 330 are added to the function module 300 equipped with an intrinsic function performing unit 310, which is implemented to perform an own function of the device. The fault testing unit 320 inspects fault of the device, that is, fault of the intrinsic function performing unit 310, and outputs the inspected result to the monitoring module 400. The monitoring result processing unit 330 is used when the device operates in the master mode. The monitoring result processing unit 330 outputs a fault breakdown obtained by the monitoring result through the intrinsic function performing unit 310.

The fault testing unit 320 reads an individual component list 520, in which information about each component that is a belonging device is recorded, from the information storage unit 500, and refers to it. That is, the fault testing unit 320 produces a component-wise self-test result after self-testing each component constituting the belonging device with reference to the individual component list 520.

The test result is input to a monitoring administration unit 410 of the monitoring module 400 requesting a test.

FIG. 5 illustrates an example of the individual component list 520 according to an exemplary embodiment of the present invention. The individual component list 520 includes a device identifier (ID) 550 and a constituent (e.g., configuration) component 560. In this non-limiting example, a digital television (DTV) device having an ID ‘0xXX’ includes components having IDs ‘0xXXX8’ and ‘0xXXX9’. If the fault testing is directed to the fault testing unit 320 of the DTV device, components including the Ethernet and IEEE 1394 are tested and the component-wise self-test result is output.

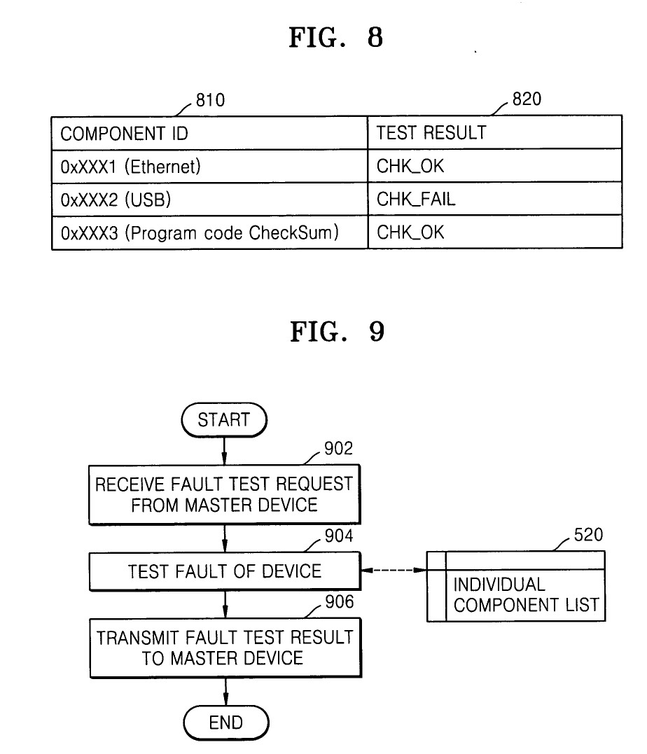

FIG. 8 illustrates an example of the component-wise self-test result according to an exemplary embodiment of the present invention. The self-test result which the fault testing unit 320 outputs is the test result consisting of a component ID 810 and a test result 820. The monitoring administration unit 410 receives the test result and makes a packet adding a device ID for identifying the belonging device and transmits the packet to the master device. Only information about a component at which a fault occurs is transmitted to the master device so that the amount of transmitted data can be minimized. In other words, in the example of FIG. 8, a packet including only the component ID ‘0xXXX2’ and the device ID may be transmitted as the fault test result. The monitoring administration unit 410 of the master device can determine fault of a USB component of the slave device corresponding to the device ID with reference to a common component list described below.

The monitoring module 400 is the module which manages the function module 300 and the group connected via the network. The monitoring module 400 includes the monitoring administration unit 410 and a group management unit 420. The monitoring administration unit 410 differently operates depending on whether the belonging device is the master device or the slave device. That is, the role of the monitoring administration unit 410 when the device operates in the master mode and the role of the monitoring administration unit 410 when the device operates in the slave mode are different.

When the device operates in the slave mode, the monitoring administration unit 410 receives a fault test request from the master device, gives an instruction to test fault of the device to the fault testing unit 320 and transmits the test result input from the fault testing unit 320 to the master device.

When the device operation is in the master mode, the monitoring administration unit 410 receives the fault test result from another device within a group, that is, from the slave device, and collects it. That is, the monitoring administration unit 410 analyzes the received fault test result, determines whether or not a device of which fault occurs exists, grasps whether any kind of component of the device is the fault, and prepares a fault breakdown. The prepared fault breakdown is reported to the user through the monitoring result processing unit 330 of the master device. The monitoring administration unit 410 of the master device may request a fault test at a designated time to the devices within the group periodically, for example but not by way of limitation.

The monitoring result processing unit 330 is the module which reports the fault breakdown input from the monitoring administration unit 410 to the user when the device operates in the master mode. A report method is determined with reference to service configuration information 530, in which action matters are recorded when fault occurs.

The service configuration information 530 may be differently set up according to the type of the device. For example but not by way of limitation, when the device having a display such as a digital TV is the master device, the action matters which indicate to output the monitoring result to the display can be recorded. Moreover, in case of a device in which an Internet connection is possible, such as a PC, the action matters which indicate to transmit the monitoring result to an external device can be recorded. That is, each device within the group differently operates according to its own service configuration information.

More specifically, when the PC is the master device, information about the device of which fault occurs can be recorded in a web server of an A/S center and a fault breakdown can be left as a log. When the TV is the master device, the fault breakdown of the device of which fault occurs can be output to a monitor and follow up that the user reports the fault breakdown to the A/S center is possible.

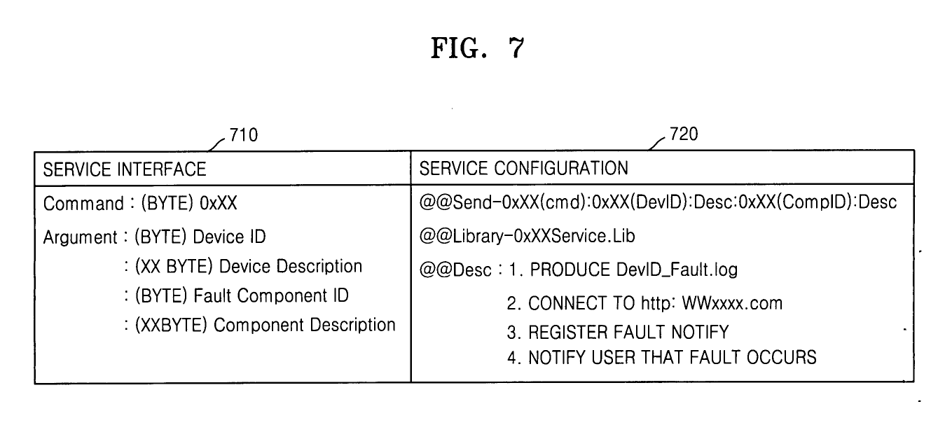

FIG. 7 illustrates an example of the service configuration information 530 according to an exemplary embodiment of the present invention. The monitoring administration unit 410 instructs a report to be made to the monitoring result processing unit 330 using a service interface 710. If a command and a parameter (argument) are delivered to the monitoring result processing unit 330, the monitoring result processing unit 330 takes action about the fault according to the content defined in the service configuration 720. In the example of FIG. 7, if a report instruction in which the device and the component of which fault occurs are set to a parameter is received, the monitoring result processing unit 330 performs successive operations of producing DevID_Fault.log in which the fault breakdown is recorded, using a library 0xXXService Lib and connecting to the web and informing the fault.

Information about each component of the device within the group is recorded in the common component list 510 stored in the information storage unit 500, and all devices within the group share the information. Further, the common component list 510 is referred to analyze the test result, which the monitoring administration unit 410 receives from another device within the group, and to prepare the fault breakdown.

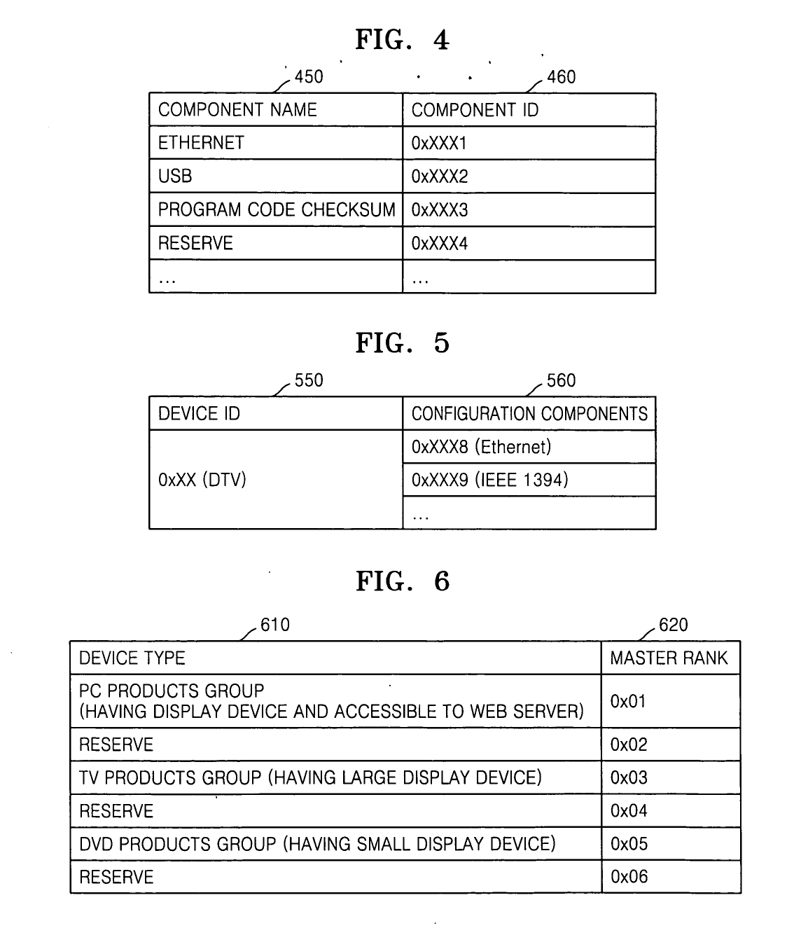

FIG. 4 illustrates an example of the common component list 510 according to an exemplary embodiment of the present invention. Component names 450 and component IDs 460 constituting the devices which can become the member of the group are enumerated in the common component list 510. For example but not by way of limitation, when the monitoring administration unit 410 produces a log in which the fault breakdown is recorded, if the component name, instead of the component ID included in the test result received from the slave device is used in the log (i.e., if the component name ‘Ethernet’, instead of ‘0xXXX1’, is used in the log), the user can easily grasp the component of which fault occurs.

Group management information 540 in which the information about the devices within the group is recorded can be stored in the information storage unit 500. This information is used for managing the group. Therefore, a group ID, an ID of the master device, and information about the devices within the group can be recorded. The information about each device may include a device ID, a description and a master rank about the device. The master rank is information for determining the master device.

The group management unit 420 manages group joining of the new device using the group management information 540, determines one device among the devices within the group as the master device and the other device as the slave device, and maintains the most up-to-date information for the master device and the slave device in the group management information 540. For example but not by way of limitation, the group management unit 420 determines the device having the highest master rank among the devices within the group as the master device with reference to the group management information 540 and updates the information about the master device of the group management information 540 as information about the device which is newly determined as the master device.

FIG. 6 illustrates an example of the master ranking rule according to an exemplary embodiment of the present invention. A master rank 620 is assigned according to the type 610 of the device. In this non-limiting example, the highest master rank is given to a PC products group, which includes a display device and is accessible to the web server; a TV products group and a DVD products group each having the display device are next. That is, the master rank of the device having the most efficient output unit is given the highest relative rank.

Like the monitoring administration unit 410, the group management unit 420 operates differently in the master mode and in the slave mode. When the group management unit 420 operates in the master mode, the group management unit 420 adds the information about the device demanding subscription to the group management information 540 to the process group joining of a new device. However, when the device of which the power source is freshly turned on, or is connected via the network, the master device needs to be re-determined before continuing the subscription processing of this device. The operation of the group management unit 420 for determining the master device is as follows.

In the beginning of the device startup process, the group management unit 420 requests the sending of information about the master device in the other devices within the group. The master device within the group transmits the information, including its own device ID and master rank to the device requesting the information. The newly initiated device compares the master rank of the master device and its own master rank before demanding the subscription. If its own master rank is higher than the master rank of the master device, the device is itself assigned as the master device. At this time, the device notifies the other devices within the group to set up the device in which oneself belongs as the master device, and the group management information which each maintains is modified. Even when the information about the master device is not received for an amount of time, that is, even in an exceptional case where receiving of the information about the master device fails, the device notifies the other devices within the group to set up the belonging device as the master device.

The example of exceptional cases includes the state that the group has not yet been generated or that the device of which power source is being now turned on within the group is the only belonging device. When the master rank of the master device is higher, the current master device continuously operates as the master device, and the new device requests the group joining to the master device and operates in the slave mode.

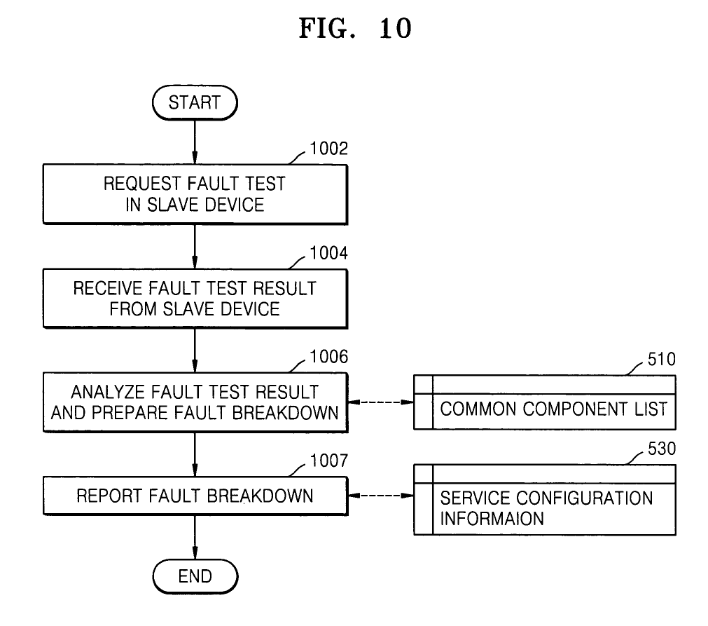

FIG. 9 illustrates a monitoring operation mechanism of a slave device according to an exemplary embodiment of the present invention. Firstly, a fault test request is received from the master device which is another device within the group in operation 902. If the fault test request is received, a self-test on components recorded in the individual component list 520 is performed so that fault of the device is tested in operation 904. The fault test result is transmitted to the master device in operation 906. At this time, the transmitted test result may be a result in which the self-test result about each component is enumerated.

FIG. 10 illustrates a monitoring action mechanism of the master device according to an exemplary embodiment of the present invention. Firstly, the master device requests fault testing to each device within a group in operation 1002. The fault test result is received from slave devices in response to the request in operation 1004. This test result can include the list of the test result and component ID as each component-wise self-test result constituting the slave device. If the received test result is analyzed and it is determined that a device of which fault occurs exists, a fault breakdown is prepared in operation 1006. At this time, a component ID may be changed into a component name which a user can easily understand, with reference to the common component list 510. The report of the prepared fault breakdown is performed with reference to service configuration information 530 in operation 1007. That is, the service configuration information 530 recording action matters when fault occurs is read and the fault breakdown is output using a method recorded in the service configuration information 530.

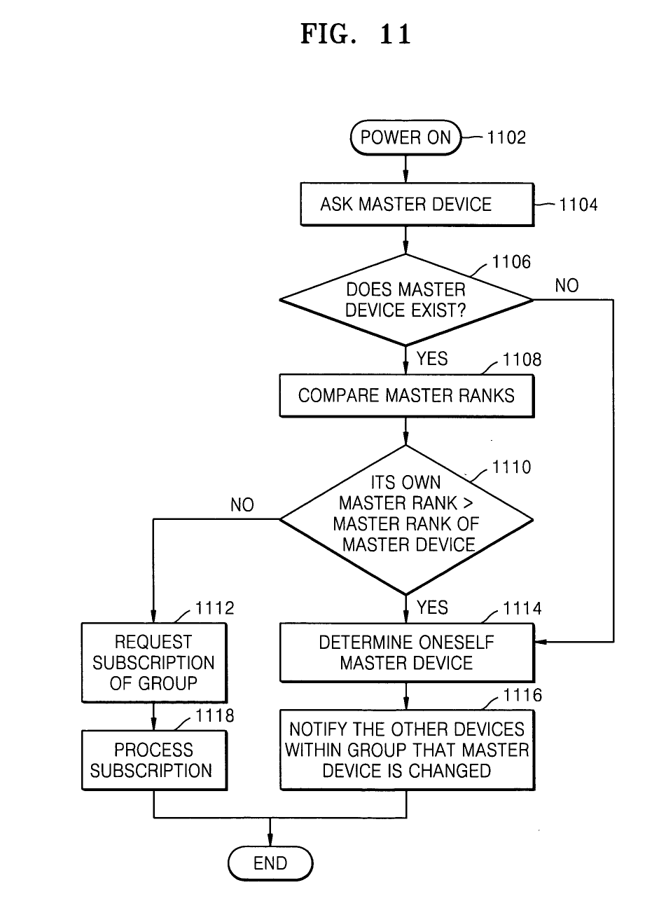

FIG. 11 illustrates a master device decision mechanism according to an exemplary embodiment of the present invention. If a power source of a device is turned on, that is, if the device connected via a network starts up in operation 1102, joining of a group is needed. However, it is necessary to firstly determine whether the master device is changed before processing subscription of a new device. To this end, the device requests the identity of the current master device in operation 1104. This is possible by requesting information in the other devices within the group. And the current master device among the devices receiving this request transmits its own information in response to this request. If the information about the master device is not received, it is determined that the master device does not exist in operation 1106.

If the information about the master device is received, that is, if the master device exists, the master rank of the current master device and its own master rank are compared in operation 1108. If its own master rank is higher than the master device in operation 1110, the device itself is determined as a new master device in operation 1114 and the device notifies the other devices within the group that the master device is changed in operation 1116. If its own master rank is lower than that of the master device in operation 1110, the change of the master device is unnecessary and the subscription of the group is requested in the master device in operation 1112. The master device requested for the subscription adds the information about the device which newly joins in the group management information and processes the subscription in operation 1118.

The master device may not exist. For example but not by way of limitation, the master device may not exist if the group has not yet been generated. When the master device does not exist in operation 1106, the group is produced and oneself is determined as the new master device in operation 1114.

Through this process, the device among devices within the group in which the master rank is the highest is determined as the master device of the group, and the other devices are determined as the slave device(s). When the new device joins the group or is added to the network, the master device is newly determined.

The exemplary embodiment can also be computer readable codes on a computer readable recording medium.

As described above, in the system and the method for monitoring a group of devices on a network according to the exemplary embodiments, since the device and the component of which fault occurs can be rapidly grasped in the plurality of group of devices, the device can be efficiently administrated.

Furthermore, since the subscription and group management of the group are dynamically made, the task which adds or removes the device to or from the group can be very easily performed.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A system for monitoring a group of devices on a network, the system comprising:
a slave device which tests a fault of a belonging device and outputs a test result; and
a master device which receives the test result from the slave device.

2. A system for monitoring a group of devices on a network, the system comprising:
a fault testing unit which tests a fault of a belonging device and outputs a test result; and
a monitoring administration unit which instructs fault testing to the fault testing unit and transmits the test result input from the fault testing unit to a master device within the group if operating in a slave mode.

3. The system of claim 2, wherein the monitoring administration unit, if operating in a master mode, receives the fault test result from another device within the group, analyzes the received test result, and outputs a fault breakdown if it is determined that a device of which the fault occurs exists, and
the system further comprises a monitoring result processing unit which outputs the fault breakdown input from the monitoring administration unit.

4. The system of claim 3, wherein the monitoring administration unit, if operating in a master mode, requests the fault test in the another device and if operating in a slave mode, instructs the fault test to the fault testing unit if the monitoring administration unit receives a fault test request.

5. The system of claim 4, further comprising an information storage unit including service configuration information in which action matters when the fault occurs are recorded, wherein the monitoring result processing unit outputs the fault breakdown by referring to the service configuration information.

6. The system of claim 5, wherein the information storage unit further comprises group management information in which information about the another device is recorded, and
the system further comprises a group management module which manages group joining of a new device using the group management information and determines one device among devices within the group as a master device operating in a master mode, and the other device as a slave device operating in a slave mode.

7. The system of claim 6, wherein the group management module determines a device among devices within the group of which a master rank is the highest as the master device by referring to the group management information.

8. The system of claim 7, wherein, if operating in the master mode, the group management module adds information about the device demanding subscription to the group management information if the group management module receives a group subscription request, and the group management module sends information including an identifier and a master rank of a belonging device if the group management module receives a request for the information about the master device.

9. The system of claim 8, wherein the group management module requests information about the master device in the another device, if a master rank of the belonging rank is higher than a master rank of the master device included in the received information or fails to receive the information about the master device, notifies the another device that the belonging device is set to the master device, and if not, the group management module requests group joining in the master device.

10. The system of claim 7, wherein the information storage unit further comprises an individual component list in which information about each component constituting the belonging device is recorded, and
if the fault testing unit receives the test instruction, the information storage unit performs a self-test on components belonging to the individual component list and outputs the self-test result as the test result.

11. The system of claim 10, wherein the information storage unit further comprises a common component list in which information about each component of the another device is recorded, and
the monitoring management unit, if operating in the master mode, prepares the fault breakdown by referring to the common component list if the monitoring management unit receives the test result from the other devices within the group.

12. The system of claim 4, wherein the monitoring management unit, if operating in the master mode, requests the fault test to the another device in each period.

13. The system of claim 5, wherein the service configuration information is different according to a type of the belonging device.

14. The system of claim 13, wherein the service configuration information comprises action matters to instruct to output the fault breakdown to a display of the belonging device.

15. The system of claim 13, wherein the service configuration information comprises action matters to instruct to transmit the fault breakdown to an external device.

16. A method of monitoring a group of devices on a network, the method comprising:
receiving a fault test request from a master device within the group;
testing fault of a belonging device to the group if the request is received; and
transmitting the test result to the master device.

17. The method of claim 16, wherein the testing of the fault of the device further comprises performing a self-test on each component by referring to an individual component list in which information about components of the belonging device is recorded, and
the transmitting of the test result comprises transmitting the self-test result on each of the components.

18. A method of monitoring a group of devices on a network, the method comprising:
requesting a fault test to each of the devices within the group;
receiving the test result from each of the devices in response to the request;
analyzing the received test result is analyzed;
if it is determined that a device of which fault occurs exists based on the analyzing, preparing a fault breakdown; and
outputting the fault breakdown.

19. The method of claim 18, wherein the preparing of the fault breakdown further comprises generating information including names of components of which fault occurs, by referring to a common component list in which information about components of devices within the group is recorded.

20. The method of claim 18, wherein the outputting of the fault breakdown comprises:
reading service configuration information in which action matters when fault occurs are recorded; and
outputting the fault breakdown using a method recorded in the service configuration information.

21. A method of monitoring a group of devices on a network, the method comprising:
determining a device having a highest master rank among the devices within the group as a master device of the group;
determining another device of the devices as a slave, device;
requesting a fault test in the slave device using the master device;
testing a fault of a device if the fault test request is received;
transmitting a test result to the master device;
determining whether a device at which fault occurs exists based on a test result transmitted from the slave device;
if it is determined that the device at which the fault occurs exists, preparing a fault breakdown; and
outputting the fault breakdown.

22. The method of claim 21, further comprising:
if a device connected via a network starts up, demanding subscription to the group; and
adding information about the device demanding subscription to group management information in which information about devices subscribed in the group is recorded to process group joining of a new device.

23. The method of claim 22, wherein the determining of the master device comprises:
if a master rank of the device demanding the subscription is higher than a master rank of the current master device, determining the device demanding the subscription as the master device; and
notifying other ones of the devices within the group that the belonging device is set to the master device.

24. The method of claim 22, wherein the determining of the master device further comprises, if a master device does not exist in the group, determining the device demanding the subscription as the master device.

25. The method of claim 21, wherein the requesting of the fault test is performed in each period.

26. The method of claim 21, wherein the testing of the fault of the device further comprises performing a self-test on each component by referring to an individual component list in which information about components of the belonging device is recorded, and
the transmitting of the test result further comprises transmitting the self-test result on each component.

27. The method of claim 26, wherein the preparing of the fault breakdown further comprises generating information including names of components at which fault occurs, by referring to a common component list in which information about components of the devices within the group is recorded.

28. The method of claim 21, wherein the outputting of the fault breakdown comprises:
reading service configuration information in which action matters when fault occurs are recorded; and
outputting the fault breakdown using a method recorded in the service configuration information.
